(19) United States
(12) Patent Application Publication
(10) Pub. No.: US 2013/0259003 A1
(43) Pub. Date: Oct. 3, 2013

(54) APPARATUS AND METHOD FOR PERFORMING WIRELESS CONNECTION RE-ESTABLISHMENT IN A MULTIPLE COMPONENT CARRIER SYSTEM

(71) Applicants: Ki Bum Kwon, Seoul (KR); Myung Cheul Jung, Seoul (KR)

(72) Inventors: Ki Bum Kwon, Seoul (KR); Myung Cheul Jung, Seoul (KR)

(73) Assignee: PANTECH CO., LTD., Mapo-gu, SEOUL (KR)

(21) Appl. No.: 13/993,445

(22) PCT Filed: Dec. 15, 2011
(86) PCT No.: PCT/KR2011/009688

§ 371 Date: Jun. 12, 2013

(30) Foreign Application Priority Data
Dec. 16, 2010 (KR) 10-2010-0129203
Dec. 7, 2011 (KR) 10-2011-0129988

(51) Int. Cl. H04W 36/08

(52) U.S. Cl. CPC H04W 36/08
USPC 370/331

(57) ABSTRACT

Provided are an apparatus and a method for performing radio connection re-establishment in a multiple component carrier system. The present description discloses a terminal including: a cell selection unit which selects a cell for said radio connection re-establishment upon occurrence of failure of wireless connection; a sub-serving cell setting information constructing unit which constructs sub-serving cell setting information for specifying at least one sub-serving cell set for the terminal; a message transmitting unit which transmits a radio connection re-establishment request message for requesting procedures for the radio connection re-establishment and a radio connection re-establishment completion message indicating the completion of the procedures for the radio connection re-establishment, to a base station through the selected cell; and a message receiving unit which receives a radio connection re-establishment message as a response to said radio connection re-establishment request message.

### CROSS-REFERENCE TO RELATED APPLICATIONS

This application is the National Stage Entry of International Application PCT/KR2011/009688, filed on Dec. 15, 2011, and claims priority from and the benefit of Korean Patent Application No. 10-2010-0129203, filed on Dec. 16, 2010, and Korean Patent Application No. 10-2011-0129988, filed on Dec. 7, 2011, all of which are incorporated herein by reference in their entireties for all purposes as if fully set forth herein.

### BACKGROUND

1. Field

The present invention relates to wireless communication and, more particularly, to an apparatus and method for performing radio connection re-establishment in a multiple is component carrier system.

2. Discussion of the Background

The next-generation mobile communication system having an object of providing various types of multimedia services must guarantee quality of service having a specific level or higher for each of the services provided to subscribers. The comprehensive quality of service that determines a level of satisfaction of a user for a specific service is defined as Quality of Service (QoS), and the QoS is determined by various and complex factors applied to each service.

A wireless network is used based on the concept of various types of bearer services defined to guarantee QoS of a specific level for service between terminations (between users or between a user and a server). Service between terminations is classified into several sections through various types of network elements and supported. Thus, data transmission service in each section is independently defined, and QoS for the data transmission service is guaranteed. Accordingly, a wireless connection service for the transmission of data that is provided in a specific section is defined as a bearer service.

A Radio Bearer (RB) is a bearer service related to the operation of a radio interface protocol and is a service provided to a higher protocol layer through the Radio Resource Control (RRC) layer of the radio interface protocol. The RB includes a Data Radio Bearer (DRB) and a Signaling Radio Bearer (SRB). The DRB is an RB responsible for providing data service, and the SRB is an RB responsible for sending various types of RRC messages for RRC connection establishment with a wireless network in order to provide DRB service. That is, the SRB is different from the DRB responsible for user data transmission.

In order for a terminal to be provided with DRB service, an SRB for RRC connection must be first configured in the terminal. If a channel state is unstable although RRC connection has been set up, a data loss in a radio channel can occur. This data loss results in an error of an SRB or DRB between the terminal and a base station.

Meanwhile, in a multiple component carrier system, one or more serving cells can be set and configured between a base station and a terminal. In this system, if a radio resource control channel between the base station and the terminal temporally occurs due to the deterioration of a radio channel, a method of reconfiguring secondary serving cells other than a primary serving cell in which the radio resource control channel has been configured has not yet been determined.

### SUMMARY

An object of the present invention is to provide an apparatus and method for performing radio connection re-establishment in a multiple component carrier system.

Another object of the present invention is to provide an apparatus and method for reconfiguring a radio resource control channel, which are capable of recovering all available serving cells when serving cells other than a serving cell in which a radio resource control channel has been configured are present.

In accordance with an aspect of the present invention, there is provided User Equipment (UE) performing radio connection re-establishment in a multiple component carrier system. The UE includes a cell selection unit selecting a cell for the reconfiguration of wireless connection, an secondary serving cell Configuration Information (SCell CI) configuration unit configuring SCell CI that specifies at least one secondary serving cell configured in the UE, a message transmission unit sending a radio connection re-establishment request message comprising the SCell CI and a radio connection re-establishment completion message, indicating that the radio connection re-establishment procedure has been completed, to an evolved-NodeB (eNB) through the selected cell, and a message reception unit receiving a radio connection re-establishment message as a response to the radio connection re-establishment request message.

In accordance with another aspect of the present invention, there is provided a method of UE performing radio connection re-establishment in a multiple component carrier system. The method includes the steps of selecting a cell for the reconfiguration of radio connection, configuring SCell CI specifying at least one secondary serving cell configured in the UE, sending a radio connection re-establishment request message including the SCell CI to an eNB through the selected cell, receiving a radio connection re-establishment message as a response to the radio connection re-establishment request message, and sending a radio connection re-establishment completion message, indicating that a radio connection re-establishment procedure has been completed, to the eNB through the selected cell.

In accordance with yet another aspect of the present invention, there is provided an eNB performing radio connection re-establishment in a multiple component carrier system. The eNB includes an uplink message reception unit receiving a radio connection re-establishment request message, including SCell CI that specifies at least one secondary serving cell configured in UE, and a radio connection re-establishment completion message, indicating that a radio connection re-establishment procedure has been completed, from UE through a primary serving cell, an SCell modification information configuration unit determining whether to remove or change the at least one secondary serving cell with reference to the SCell CI and configuring SCell modification information indicative of the addition, removal, or change of a secondary serving cell based on the determination, and a downlink message transmission unit sending a radio connection re-establishment message, including the SCell modification information, to the UE as a response to the radio connection re-establishment request message.

In accordance with yet another aspect of the present invention, there is provided a method of an eNB performing radio connection re-establishment in a multiple component carrier system. The method includes the step of receiving a radio connection re-establishment request message, including SCell CI specifying at least one secondary serving cell configured in UE, from the UE through a primary serving cell, determining whether to remove or change the at least one secondary serving cell with reference to the SCell CI, configuring SCell modification information indicative of the addition, removal, or change of a secondary serving cell based on the determination, sending a radio connection re-establishment message, including the SCell modification information, to the UE as a response to the radio connection re-establishment request message, and receiving a radio connection re-establishment completion message, indicating that a radio connection re-establishment procedure has been completed, from the UE through the primary serving cell.

In accordance with yet another aspect of the present invention, there is provided UE performing radio connection re-establishment in a multiple component carrier system. The UE includes a cell selection unit selecting a cell for the re-establishment of radio connection when the radio connection fails, a SCell CI configuration unit configuring SCell CI that specifies at least one secondary serving cell configured in the UE, a message transmission unit sending a radio connection re-establishment request message, requesting the re-establishment procedure of the radio connection, and a radio connection re-establishment completion message, indicating that the radio connection re-establishment procedure has been completed, to an eNB through the selected cell, and a message reception unit receiving a radio connection re-establishment message as a response to the radio connection re-establishment request message.

The SCell CI may be included in any one of the radio connection re-establishment request message and the radio connection re-establishment completion message.

In accordance with yet another aspect of the present invention, there is provided a method of UE performing radio connection re-establishment in a multiple component carrier system. The method includes the steps of selecting a cell for the re-establishment of radio connection when the radio connection fails, configuring SCell CI that specifies at least one secondary serving cell configured in the UE, sending a radio connection re-establishment request message, requesting the re-establishment of the radio connection to an eNB through the selected cell, receiving a radio connection re-establishment message as a response to the radio connection re-establishment request message, and sending a radio connection re-establishment completion message, indicating that a radio connection re-establishment procedure has been completed, to the eNB through the selected cell.

The SCell CI may be included in any one of the radio connection re-establishment request message and the radio connection re-establishment completion message.

In accordance with yet another aspect of the present invention, there is provided an eNB performing radio connection re-establishment in a multiple component carrier system. The eNB includes an uplink message reception unit receiving a radio connection re-establishment request message, requesting re-establishment of radio connection, or a radio connection re-establishment completion message, indicating that a radio connection re-establishment procedure has been completed, from UE through a primary serving cell, an secondary cell (SCell) modification information configuration unit making a determination of whether to remove or change at least one secondary serving cell configured in the UE with reference to SCell CI, included in at least one of the radio connection re-establishment request message and the radio connection re-establishment completion message and specifying the at least one secondary serving cell, and configuring SCell modification information indicative of an addition, removal, or change of a secondary serving cell based on the determination, and a downlink message transmission unit sending a radio connection re-establishment message, comprising the SCell modification information, to the UE as a response to the radio connection re-establishment request message.

In accordance with yet another aspect of the present invention, there is provided a method of an eNB performing radio connection re-establishment in a multiple component carrier system. The method includes the steps of receiving a radio connection re-establishment request message, requesting the re-establishment of radio connection when the radio connection fails, or a radio connection re-establishment completion message, indicating that the re-establishment of the radio connection has been completed, from UE through a primary serving cell, and sending a radio connection re-establishment message, comprising secondary serving cell (SCell) modification information indicating whether at least one secondary serving cell configured in the UE is to be removed or changed based on SCell configuration information included in at least one of the radio connection re-establishment request message and the radio connection re-establishment completion message and specifying the at least one secondary serving cell, to the UE.

If secondary serving cell configuration information in a previous Carrier Aggregation (CA) environment is different from secondary serving cell configuration information in a CA environment in an RRC connection re-establishment procedure, a change of a configuration through the addition/change/removal of secondary serving cells previously configured between UE and an eNB can be performed without the exchange of additional messages by using secondary serving cell configuration information when performing an RRC connection re-establishment procedure.

### BRIEF DESCRIPTION OF THE DRAWINGS

FIG. 1 is a block diagram showing a wireless communication system to which the present invention is applied.

FIG. 2 is an explanatory diagram illustrating an intra-band contiguous CA to which the present invention is applied.

FIG. 3 is an explanatory diagram illustrating an intra-band non-contiguous CA to which the present invention is applied.

FIG. 4 is an explanatory diagram illustrating an inter-band CA to which the present invention is applied.

FIG. 5 shows an example of a protocol structure for supporting multiple carriers to which the present invention is applied.

FIG. 6 shows an example of a frame structure for a multiple carrier operation to which the present invention is applied.

FIG. 7 shows linkage between a downlink component carrier and an uplink component carrier in a multiple carrier system to which the present invention is applied.

FIG. 8 is an explanatory diagram illustrating the concept of a serving cell and neighbor cells to which the present invention is applied.

FIG. 9 is an explanatory diagram illustrating the concept of primary serving cells and secondary serving cells to which the present invention is applied.

FIG. 10 is a flowchart illustrating an RRC connection re-establishment procedure in accordance with an example of the present invention.

FIG. 11 is a flowchart illustrating the RRC connection re-establishment of UE in accordance with an example of the present invention.

FIG. 12 is a flowchart illustrating the RRC connection re-establishment of UE in accordance with another example of the present invention.

FIG. 13 is a flowchart illustrating the RRC connection re-establishment of a BS in accordance with an example of the present invention.

FIG. 14 is a flowchart illustrating the RRC connection re-establishment of a BS in accordance with another example of the present invention.

FIG. 15 shows a scenario by which the configuration of a serving cell is changed in accordance with an example of the present invention.

FIG. 16 shows a scenario by which the configuration of a serving cell is changed in accordance with another example of the present invention.

FIG. 17 shows a scenario by which the configuration of a serving cell is changed in accordance with yet another example of the present invention.

FIG. 18 is a block diagram of UE and a BS which perform RRC connection re-establishment in accordance with an example of the present invention.

### DETAILED DESCRIPTION OF THE ILLUSTRATED EMBODIMENTS

Hereinafter, in this specification, some exemplary embodiments of the present invention will be described in detail with reference to the accompanying drawings. It is to be noted that in assigning reference numerals to elements in the drawings, the same reference numerals denote the same elements throughout the drawings even in cases where the elements are shown in different drawings. Furthermore, in describing the embodiments of the present invention, a detailed description of the known functions and constitutions will be omitted if it is deemed to make the gist of the present invention unnecessarily vague.

Furthermore, in describing the elements of this specification, terms, such as the first, the second, A, B, (a), and (b), may be used. However, although the terms are used only to distinguish one element from the other element, the essence, order, or sequence of the elements is not limited by the terms. When it is said that one element is ‘connected’, ‘combined’, or ‘coupled’ with the other element, the one element may be directly connected or coupled with the other element, but it should also be understood that a third element may be ‘connected’, ‘combined’, or ‘coupled’ between the two elements.

Furthermore, in this specification, a wireless communication network is described as the target, but tasks performed over the wireless communication network can be performed in a process by which a system (e.g., a base station) managing the corresponding wireless communication network controls the wireless communication network and sends data or can be performed by a terminal associated with the corresponding wireless network. In accordance with the present invention, the wireless communication system includes a communication system supporting one or more component carriers.

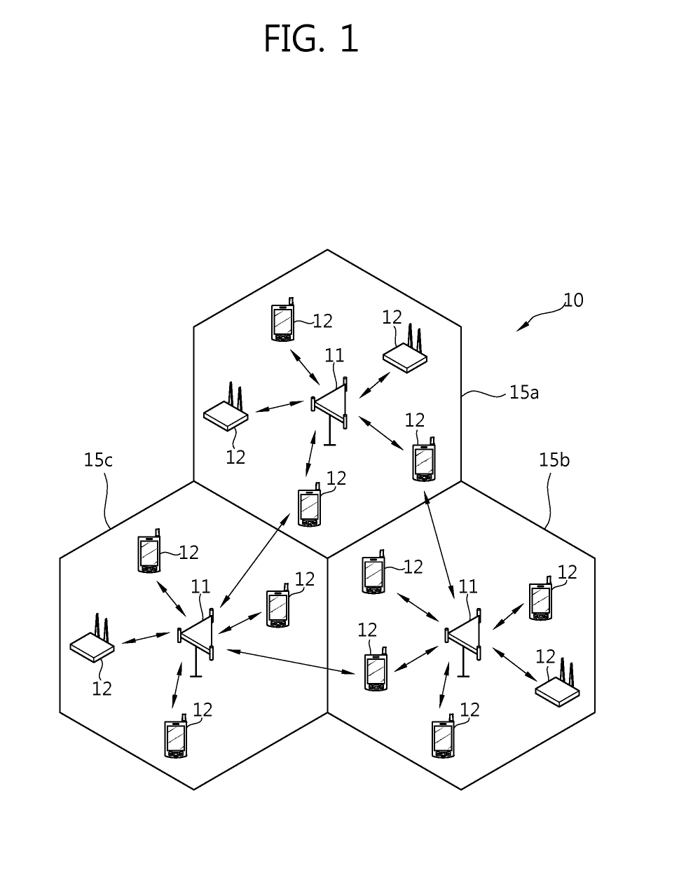

FIG. 1 is a block diagram showing a wireless communication system to which the present invention is applied. The wireless communication system can have the network structure of an Evolved-Universal Mobile Telecommunications System (E-UMTS). The E-UMTS system may also be called a Long Term Evolution (LTE) system. The wireless communication systems are widely deployed in order to provide various types of communication services, such as voice and packet data.

Meanwhile, multiple access schemes applied to the wireless communication system are not limited. Various types of multiple access schemes, such as Code Division Multiple Access (CDMA), Time Division Multiple Access (TDMA), Frequency Division Multiple Access (FDMA), Orthogonal Frequency Division Multiple Access (OFDMA), Single Carrier-FDMA (SC-FDMA), OFDM-FDMA, OFDM-TDMA, and OFDM-CDMA, can be used.

Here, UL transmission and DL transmission can be performed in accordance with a Time Division Duplex (TDD) method using different times or a Frequency Division Duplex (FDD) method using different frequencies.

First, referring to FIG. 1, a plurality of the wireless communication systems 10 are widely deployed in order to provide a variety of communication services, such as voice and packet data. The wireless communication system 10 includes one or more Base Stations (BS) 11. The BSs 11 provide communication services to specific cells 15a, 15b, and 15c. Each of the cells can be classified into a plurality of areas (called sectors).

User Equipment (UE) 12 can be fixed or mobile and can also be called another terminology, such as a Mobile Station (MS), an Advanced MS (AMS), a User Terminal (UT), a Subscriber Station (SS), a wireless device, a wireless modem, or a handheld device.

The BS 11 commonly refers to a station that communicates with the UE 12, and the BS 11 can also be called another terminology, such as an evolved-NodeB (eNodeB), a Base Transceiver System (BTS), an access point, a relay, or a femto BS. The BS 11 can provide service to at least one cell. The cell is an area where the BS 11 provides communication service. An interface for transmitting user traffic or control traffic can be used between the BSs 11.

Hereinafter, downlink refers to communication from the BS 11 to the UE 12, and uplink refers to communication from the UE 12 to the BS 11. Downlink is also called a forward link, and uplink is also called a reverse link. In downlink, a transmitter can be part of the BS 11 and a receiver can be part of the UE 12. In uplink, a transmitter can be part of the UE 12 and a receiver can be part of the BS 11.

The BSs 11 can be interconnected through an X2 interface. The X2 interface is used to exchange messages between the BSs 11. The BS 11 is connected to an Evolved Packet System (EPS), more particularly, a Mobility Management Entity (MME)/Serving Gateway (S-GW) through an S1 interface. The S1 interface supports a many-to-many-relation between the BSs 11 and the MME/S-GW. In order to provide packet data service to the MME/S-GW, a PDN-GW is used. The PDN-GW is varied depending on traffic purposes or services. A PDN-GW supporting a specific service can be searched for using Access Point Name (APN) information.

An intra E-UTRAN handover is a basic handover mechanism that is used when a handover is performed between E-UTRAN access networks. The intra E-UTRAN handover includes an X2-based handover and an S1-based handover. The X2-based handover is used when UE performs a handover from a source BS to a target BS using the X2 interface. In this case, an MME/S-GW is not changed.

Through the S1-based handover, a first bearer set up among the P-GW, the MME/S-GW, the source BS, and the UE is released, and a second new bearer is set up among the P-GW, the MME/S-GW, the target BS, and the UE.

A Carrier Aggregation (CA) supports a plurality of carriers, and the CA is also called a spectrum aggregation or a bandwidth aggregation. An individual unit carrier aggregated by a CA is called a Component Carrier (hereinafter referred to as a CC). Each CC is defined by a bandwidth and a center frequency. A CA is introduced in order to support an increased throughput, prevent an increase of costs due to the introduction of wideband Radio Frequency (RF) devices, and guarantee compatibility with the existing systems.

For example, if 5 CCs are allocated as the granularity of a carrier unit having a 20 MHz bandwidth, a maximum of a 100 MHz bandwidth can be supported.

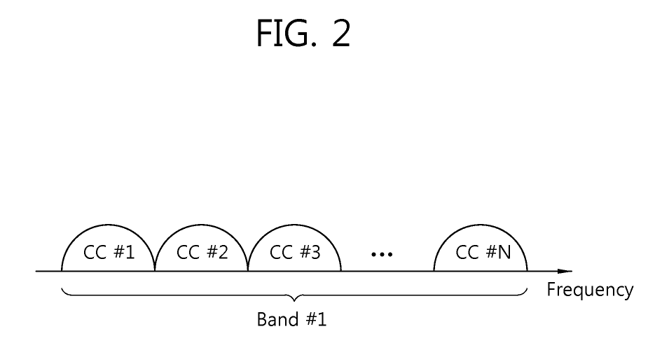

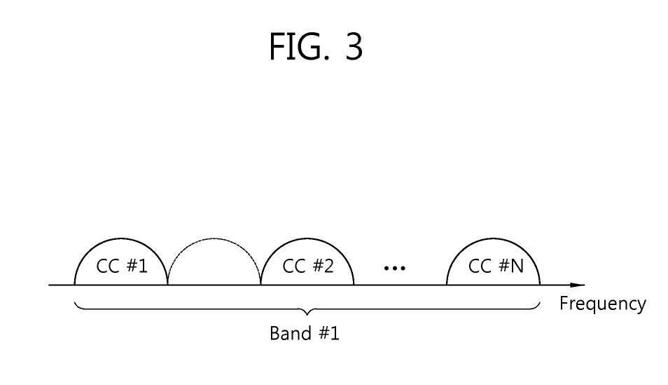

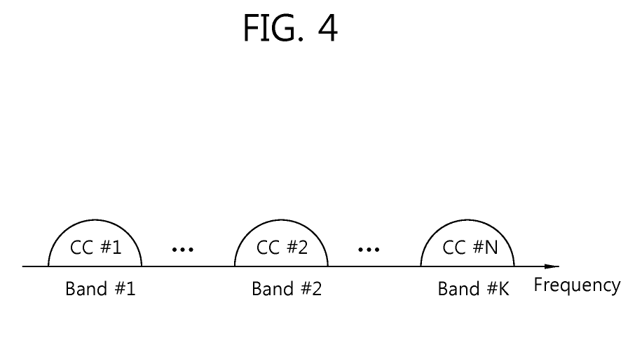

A CA can be classified into an intra-band contiguous CA, such as FIG. 2, an intra-band non-contiguous CA, such as FIG. 3, and an inter-band CA, such as FIG. 4.

First, referring to FIG. 2, the intra-band contiguous CA is performed between CCs contiguous to each other within the same operating band. For example, all of a CC#1, a CC#2, a CC#3, . . . , a CC #N, that is, aggregated CCs, are contiguous to each other.

Referring to FIG. 3, the intra-band non-contiguous CA is performed between non-contiguous CCs. For example, a CC#1 and a CC#2, that is, aggregated CCs, are spaced apart from each other at a specific frequency.

Referring to FIG. 4, when a plurality of CCs is present in the inter-band CA, one or more of the plurality of CCs are aggregated on different frequency bands. For example, a CC #1, that is, an aggregated CC, is present in an operating band #1 and a CC #2, that is, an aggregated CC, is present in an operating band #2.

The number of aggregated downlink CCs can be set differently from the number of aggregated uplink CCs. A case where the number of downlink CCs is identical with the number of uplink CCs is called a symmetric aggregation, and a case where the number of downlink CCs is different from the number of uplink CCs is called an asymmetrical aggregation.

Furthermore, CCs can have different sizes (i.e., bandwidths). For example, assuming that 5 CCs are used to form a 70 MHz band, a resulting configuration can be, for example, 5 MHz CC (carrier #0)+20 MHz CC (carrier #1)+20 MHz CC (carrier #2)+20 MHz CC (carrier #3)+5 MHz CC (carrier #4).

Hereinafter, a multiple carrier system refers to a system which supports a CA. In a multiple carrier system, a contiguous CA and/or a non-contiguous CA can be used. Furthermore, either a symmetrical aggregation or an asymmetrical aggregation can be used.

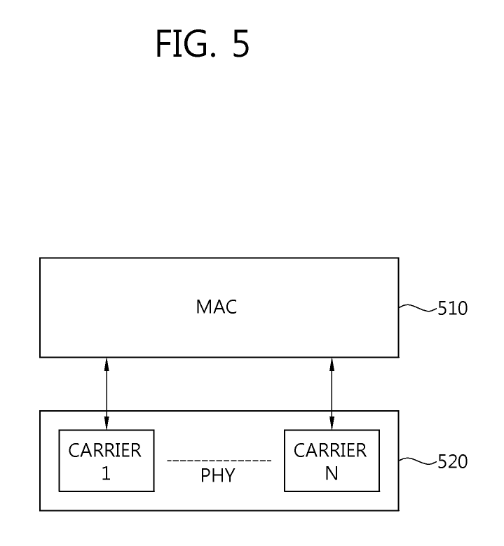

FIG. 5 shows an example of a protocol structure for supporting multiple carriers to which the present invention is applied.

Referring to FIG. 5, a common Medium Access Control (MAC) entity 510 manages a physical layer 520 using a plurality of carriers. An MAC management message transmitted on a specific carrier can be applied to other carriers. That is, the MAC management message is a message which can control other carriers including the specific carrier. The physical layer 520 can be operated in Time Division Duplex (TDD) and/or Frequency Division Duplex (FDD).

There are several physical control channels used in the physical layer 520. A physical downlink control channel (PDCCH) through which physical control information is transmitted informs UE of the resource allocation of a paging channel (PCH) and a downlink shared channel (DL-SCH) and Hybrid Automatic Repeat Request (HARQ) information related to the DL-SCH. The PDCCH can carry an uplink grant that informs UE of resources allocation for uplink transmission.

A physical control format indicator channel (PCFICH) informs UE of the number of OFDM symbols used in PDCCHs, and the PCFICH is transmitted in each frame. A physical is hybrid ARQ indicator channel (PHICH) carries an HARQ ACK/NAK signal in response to uplink transmission. A physical uplink control channel (PUCCH) carries HARQ ACK/NAK for downlink transmission, a scheduling request, and uplink control information, such as a Channel Quality Indicator (CQI). A physical uplink shared channel (PUSCH) carries an uplink shared channel (UL-SCH).

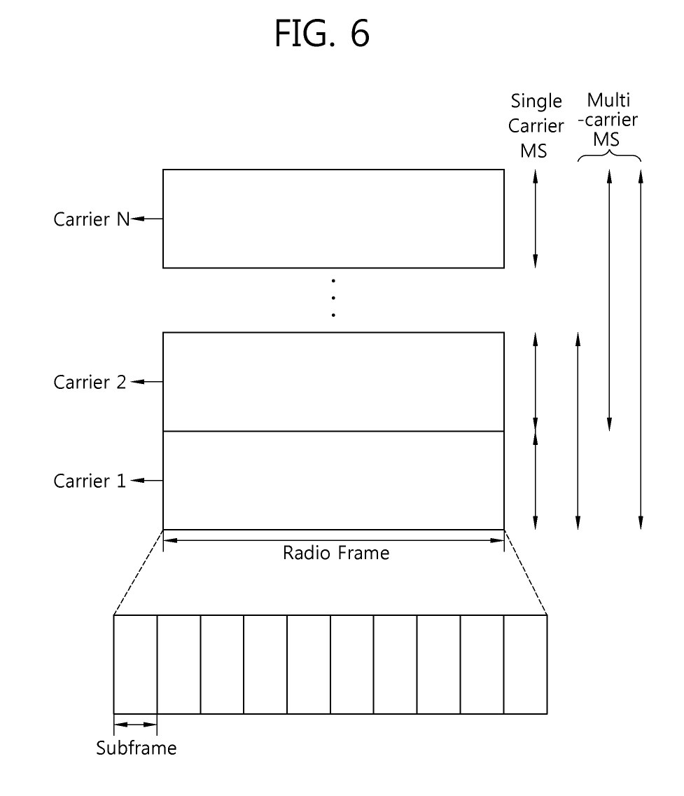

FIG. 6 shows an example of a frame structure for a multiple carrier operation to which the present invention is applied.

Referring to FIG. 6, a radio frame consists of 10 subframes. Each of the subframes includes a plurality of OFDM symbols. Each CC can have its own control channel (e.g., a PDCCH). The CCs can be contiguous to each other or may not be contiguous to each other. UE can support one or more CCs depending on its capability.

A CC can be divided into a fully configured CC and a partially configured CC depending on its directivity. The fully configured CC is a bidirectional carrier, and it refers to a carrier in which all control signals and data can be transmitted and/or received. The partially configured CC is a unidirectional carrier, and it refers to a carrier in which only downlink data can be transmitted. The partially configured CC can be chiefly used in Multicast and Broadcast Service (MBS) and/or a Single Frequency Network (SFN).

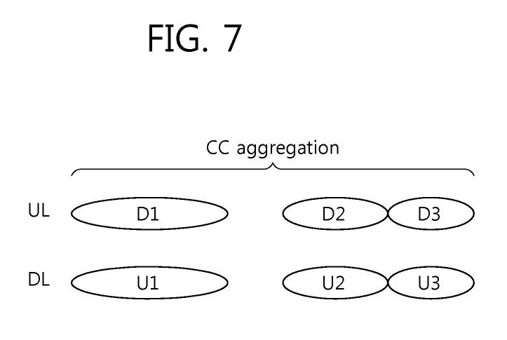

FIG. 7 shows linkage between a downlink component carrier and an uplink component carrier in a multiple carrier system to which the present invention is applied.

Referring to FIG. 7, in downlink, downlink component carriers (hereinafter referred to as DL CCs) D1, D2, and D3 are aggregated. In uplink, uplink component carriers (hereinafter referred to as UL CCs) U1, U2, and U3 are aggregated. Here, Di is an index of a DL CC, and Ui is an index of an UL CC (i=1, 2, 3).

In an FDD system, a DL CC and an UL CC are linked to each other in a 1:1 way. Each of the D1 and the U1, the D2 and the U2, and the D3 and the U3 is linked to each other in a 1:1 way. UE establishes linkage between the DL CCs and the UL CCs based on system information transmitted on a logical channel BCCH or a UE-dedicated RRC message transmitted on a DCCH. Each linkage may be established in a cell-specific way or may be established in a UE-specific way.

Examples of an UL CC linked to a DL CC are as follows.

1) An UL CC on which UE will transmit ACK/NACK information in response to data transmitted by a BS through a DL CC,

2) A DL CC on which a BS will transmit ACK/NACK information in response to data transmitted by UE through an UL CC,

3) A DL CC on which a BS will transmit a response to a Random Access Preamble (RAP), transmitted by UE starting a random access procedure through an UL CC, when the BS receives the RAP,

4) An UL CC to which uplink control information is applied when a BS transmits the uplink control information through a DL CC.

FIG. 7 illustrates only 1:1 linkage between a DL CC and an UL CC, but linkage, such as 1:n or n:1, can be established. Furthermore, an index of a CC does not coincide with the order of the CC or the position of the frequency band of the corresponding CC.

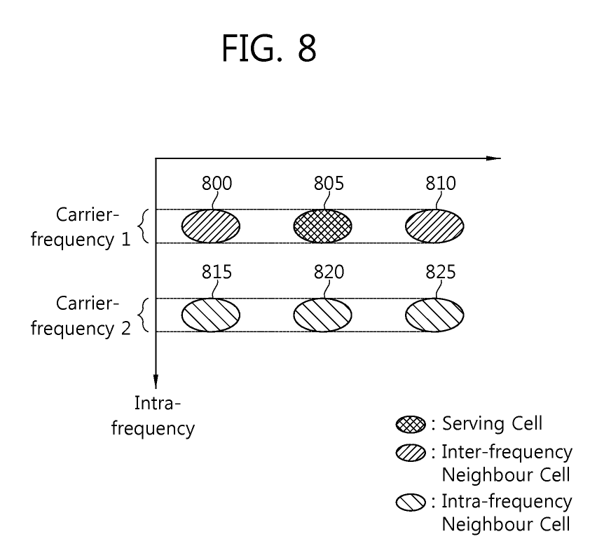

FIG. 8 is an explanatory diagram illustrating the concept of a serving cell and neighbor cells to which the present invention is applied.

Referring to FIG. 8, a system frequency band is classified into a plurality of carrier frequencies. Here, the carrier frequency refers to the center frequency of a cell. The cell can mean downlink frequency resources and uplink frequency resources. Or, the cell can mean a combination of downlink frequency resources and optional uplink frequency resources. In general, when a CA is not taken into consideration, one cell always includes a pair of uplink and downlink frequency resources.

Here, a serving cell 805 refers to a cell in which UE is now receiving service. A neighbour cell refers to a cell that neighbors the serving cell 805 geographically or on a frequency band. Neighbour cells using the same carrier frequency on the basis of the serving cell 805 are called intra-frequency neighbour cells 800 and 810. Furthermore, neighbour cells using different carrier frequencies on the basis of the serving cell 805 are called inter-frequency neighbour cells 815, 820, and 825. That is, cells which use not only the same frequency as the serving cell, but also different frequencies from the serving cell and also neighbor the serving cell can be called neighbour cells.

A DL CC may configure one serving cell, or a DL CC and an UL CC may be linked to form one serving cell. However, a serving cell is not formed of only one UL CC.

The handover of UE from the serving cell to the intra-frequency neighbour cell 800 or 810 is called an intra-frequency handover. Meanwhile, the handover of UE from the serving cell to the inter-frequency neighbour cell 815, 820, or 825 is called an inter-frequency handover.

In order for packet data to be transmitted and received through a specific cell, UE first must complete the configuration of the specific cell or a CC. Here, the configuration means a state in which the reception of system information necessary for the transmission and reception of data for the corresponding cell or CC has been completed.

For example, the configuration can include a general process of receiving common physical layer parameters necessary to transmit and receive the data, MAC layer parameters, or parameters necessary for a specific operation in the RRC layer. A configuration completion cell or CC is in the state in which packets can be instantly transmitted and received when only signaling information, indicating that the packet data can be transmitted, is received.

Meanwhile, a cell in the configuration completion state can be present in an activation state or a deactivation state. The reason why the configuration completion state is divided into the activation state and the deactivation states is to allow UE to monitor or receive a control channel (PDCCH) and a data channel (PDSCH) only in the activation state in order to minimize the battery consumption of the UE.

Activation means that traffic data is being transmitted or received or is in the ready state. In order to check resources (can be frequency, time, etc.) allocated to UE, the UE can monitor or receive the control channel (PDCCH) and data channel (PDSCH) of an activated cell.

Deactivation means a state in which traffic data cannot be transmitted or received, but measurement or the transmission/reception of minimum information is possible. UE can receive System Information (SI) necessary to receive packets from a deactivated cell. In contrast, the UE does not monitor or receive the control channel (PDCCH) and data channel (PDSCH) of the deactivated cell in order to check resources (can be frequency, time, etc.) allocated thereto.

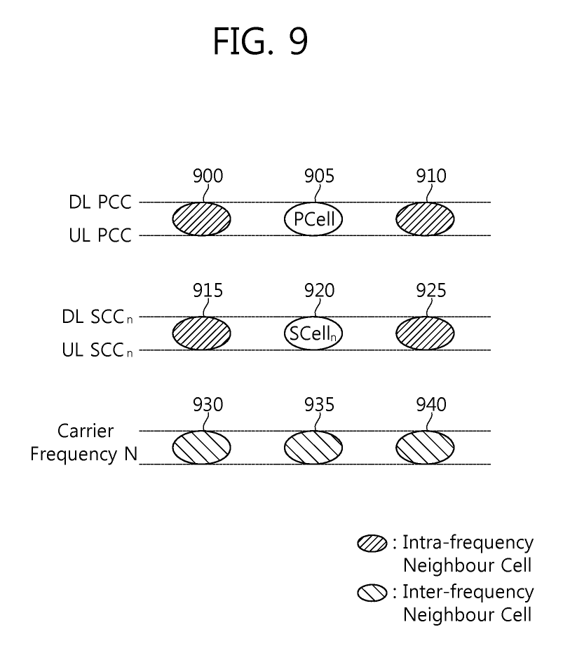

FIG. 9 is an explanatory diagram illustrating the concept of primary serving cells and secondary serving cells to which the present invention is applied.

Referring to FIG. 9, a primary serving cell (PCell) 905 refers to one serving cell which provides security input and NAS mobility information in an RRC establishment or re-establishment state. At least one cell, together with the PCell 905, can be configured to form a set of serving cells depending on UE capabilities. The at least one cell is called a secondary serving cell (SCell) 920.

Accordingly, a set of serving cells configured for one UE can include only one PCell 905 or can include one PCell 905 and at least one SCell 920.

The intra-frequency neighbour cells 900 and 910 of the PCell 905 and/or the intra-frequency neighbour cells 915 and 925 of the SCell 920 belong to the same carrier frequency. Furthermore, the inter-frequency neighbour cells 930, 935, and 940 of the PCell 905 and the SCell 920 belong to a different carrier frequency.

A DL CC corresponding to the PCell 905 is called a downlink Primary Component Carrier (DL PCC), and an UL CC corresponding to the PCell 905 is called an uplink Primary Component Carrier (UL PCC). Furthermore, in downlink, a CC corresponding to the SCell 920 is called a downlink Secondary Component Carrier (DL SCC). In uplink, a CC corresponding to the SCell 920 is called an uplink Secondary Component Carrier (UL SCC).

A PCC is a CC to which UE is connected or RRC-connected at the early stage, from among several CCs. A PCC is a special CC that is responsible for connection or RRC connection for signaling regarding a number of CCs and for the management of UE context, that is, connection information related to the UE. Furthermore, a PCC is always in the activation state when the PCC is connected to UE and is in the RRC connected mode.

An SCC is a CC allocated to UE in addition to a PCC. An SCC is an extended carrier for the additional allocation of resources to UE in addition to a PCC and can be divided into an activation state and a deactivation state. The PCell 905 and the SCell 920 have the following characteristics.

First, the PCell 905 is used to transmit a PUCCH.

Second, the PCell 905 is always activated, whereas the SCell 920 is a carrier activated or deactivated according to specific conditions.

Third, when the PCell 905 experiences a Radio Link Failure (RLF), RRC re-establishment is triggered. However, when the SCell 920 experiences an RLF, RRC re-establishment is not triggered.

Fourth, the PCell 905 can be changed by a change of a security key or a handover procedure accompanied by a random access channel (RACH) procedure. In the case of an MSG4 contention resolution, only a PDCCH indicative of MSG4 must be transmitted through the PCell 905, and MSG4 information can be transmitted through the PCell 905 or the SCell 920.

Fifth, Non-Access Stratum (NAS) information is received through the PCell 905.

Sixth, the PCell 905 always includes a pair of a DL PCC and a UL PCC.

Seventh, a different CC can be configured as the PCell 905 in each MS.

Eighth, procedures, such as the reconfiguration, addition, and removal of the SCell 920, can be performed by the RRC layer. In newly adding the SCell 920, RRC signaling can be used to transmit system information about a dedicated SCell.

The technical spirit of the present invention regarding the characteristics of the PCell 905 and the SCell 920 is not necessarily limited to the above description. The above description is only an example, the technical spirit of the present invention can include more examples.

When a radio channel is deteriorated, a BS and UE can reconfigure wireless connection in order to recover the wireless connection. Here, the PCell 905 is a serving cell in which a radio resource control channel has been configured, and the reconfiguration of the PCell 905 can be explicitly performed. In contrast, the SCell 920 has a burden that it has to experience unnecessary and complicated procedures, such as the removal, addition, change, etc. of a component carrier, due to the reconfiguration of wireless connection after the reconfiguration of the wireless connection. Furthermore, in the reconfiguration process of the PCell 905, whether or not to use previously configured SCells 920 has not been determined. A clear agreement between UE and a BS is necessary regarding the recovery procedure of the SCells 920, such as the configuration release or reconfiguration of the SCells 920.

First, RRC connection re-establishment and related bearer information are described in detail below. Basically, RRC connection re-establishment is a procedure for restarting a Signaling Radio Bearer (hereinafter referred as an SRB), in particular, operating an SRB1. The SRB includes three types: an SRB0, an SRB1, and an SRB2. The SRB0 is used for an RRC message that uses a common control channel (CCCH) logical channel. Here, a downlink CCCH is used to send information related to RRC connection establishment, connection re-establishment, the denial of connection establishment, and the denial of connection re-establishment, and an uplink CCCH is used to send information related to an RRC connection request and an RRC connection re-establishment request.

The SRB1 is used for all RRC messages that use a dedicated control channel (DCCH) logical channel. The RRC message may include part of an attached NAS message. Furthermore, the SRB1 is used for NAS messages before the SRB2 is configured. An attached downlink NAS message is used for only an attached procedure, such as bearer configuration/change/release procedures. An uplink NAS message is used to only transfer an initial NAS message during RRC connection establishment. A downlink DCCH is used to send information related to RRC connection re-establishment and connection release. Furthermore, the downlink DCCH is used to send a security mode command, a counter check, and information related to a handover between heterogeneous networks. Furthermore, the downlink DCCH is used to send downlink-related information, request UE information, and send information related to UE capability enquiry.

An uplink DCCH is used to send information related to RRC connection re-establishment completion, connection re-establishment completion, and connection establishment completion. The uplink DCCH is also used to send information related to security mode configuration completion or a security mode configuration failure, a counter check response, and proximity indication. Furthermore, the uplink DCCH is used to send information related to uplink, a measurement report, a UE information response, and information related to UE capability information.

The SRB2 is used for NAS messages that use a DCCH logical channel. The SRB2 has lower priority than the SRB1, and the SRB2 is configured by an E-UTRAN after security activation. For example, a security configuration for the SRB2 can be completed after RRC connection establishment is completed, and the SRB2 can be configured through an RRC connection re-establishment procedure.

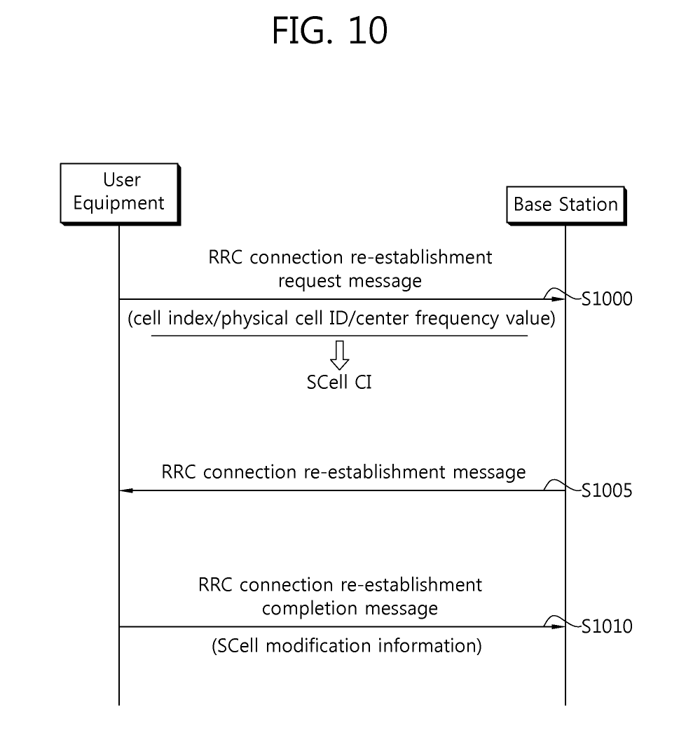

FIG. 10 is a flowchart illustrating an RRC connection re-establishment procedure in accordance with an example of the present invention. Here, in a multiple CC system, a plurality of CC can be configured in UE. Furthermore, the UE performs communication using a primary serving cell (PCell) and a secondary serving cell (SCell).

Referring to FIG. 10, the UE sends an RRC connection re-establishment request message to a BS (S1000). The RRC connection re-establishment request message includes SCell Configuration Information (CI). The SCell CI is information that indicates or specifies an SCell configured in the UE, and the SCell CI includes at least one of a cell index, a physical cell ID, and a center frequency value of an SCell. In particular, the SCell CI can be specified based on a point of time prior to the start of an RRC connection re-establishment procedure. As described above, the UE can specify which SCells configured in the UE will be selected through the SCell CI when an RLF occurs. Furthermore, the BS is able to be aware of SCells, configured in the UE when an RLF occurs, with reference to the SCell CI within the RRC connection re-establishment request message. The BS makes reference to the SCell CI when performing the addition, change, or removal of SCells for the UE.

For example, if the SCell CI includes a cell index, it is assumed that the SCell CI is {1, 2, 5}. In this case, the SCell CI indicates that SCells having cell indices 1, 2, and 5 have been configured in the UE before the RRC connection re-establishment procedure is started.

For another example, if the SCell CI includes a physical cell ID, it is assumed that the SCell CI is {4, 6}. In this case, the SCell CI indicates that SCells having physical cell IDs 4 and 6 have been configured in the UE before the RRC connection re-establishment is procedure is started.

For yet another example, if the SCell CI includes a center frequency value of an SCell, it is assumed that the SCell CI is {100 MHz, 110 MHz}. In this case, the SCell CI indicates that SCells having respective center frequency values of 100 MHz and 110 MHz have been configured in the UE before the RRC connection re-establishment procedure is started.

The BS which has received the RRC connection re-establishment request message determines whether or not RRC connection re-establishment is possible. If the RRC connection re-establishment is possible, the BS sends an RRC connection re-establishment message for RRC connection re-establishment to the UE (S1005). The RRC connection re-establishment message basically includes pieces of information necessary to perform the following procedures. 1) A procedure of reconfiguring an SRB1 and restarting data transmission corresponding to only the SRB1, and 2) a procedure of reactivating AS security without changing a security algorithm.

In particular, the RRC connection re-establishment message can include SCell modification information. The SCell modification information is information indicating whether or not the configuration of an SCell will be released, modified, or maintained. The BS obtains the SCell modification information with reference to the SCell CI of the UE. The UE is able to be aware of SCells whose configurations must be released, changed, or maintained through the SCell modification information within the RRC connection re-establishment message. If the BS determines that it is not necessary to change the SCell configuration of the UE, the BS may not include SCell modification information in the RRC connection re-establishment message. In this case, the UE can maintain an existing SCell configuration state.

When all procedures are completed after performing the RRC connection re-establishment using the information within the RRC connection re-establishment message, the UE sends an RRC connection re-establishment completion message to the BS (S1010). For example, the RRC connection re-establishment completion message includes SCell CI. The SCell CI is information that indicates or specifies an SCell configured in the UE, and the SCell CI can include at least one of a cell index, a physical cell ID, and a center frequency value of the SCell.

The SCell CI can help rapid RRC connection re-establishment and SCell configuration to be performed because an unnecessary RRC procedure, for example, an RRC connection reconfiguration procedure is omitted. Furthermore, the addition/change/removal (configuration release) procedures of SCells can become clear by the SCell CI.

For another example, the RRC connection re-establishment completion message includes SCell modification information. For yet another example, the RRC connection re-establishment completion message includes both SCell CI and SCell modification information.

As described above, SCell CI can be included in RRC messages exchanged between UE and a BS during an RRC connection re-establishment procedure while riding on the RRC connection re-establishment procedure. For example, the SCell CI may be included in an RRC connection re-establishment request message like at step S1000 and may be included in an RRC connection re-establishment completion message like at S1010. Although the SCell CI is illustrated as being included in both the RRC connection re-establishment request message and the RRC connection re-establishment completion message, it illustrates that the SCell CI can be included in any one of the RRC connection re-establishment request message and the RRC connection re-establishment completion message. If the SCell CI is included in any one message, the SCell CI is not included in the other message. This is just a difference regarding whether the SCell CI is transmitted in the start or end step of the RRC connection re-establishment procedure.

SCell CI may be included in both an RRC connection re-establishment request message and an RRC connection re-establishment completion message and transmitted, if necessary.

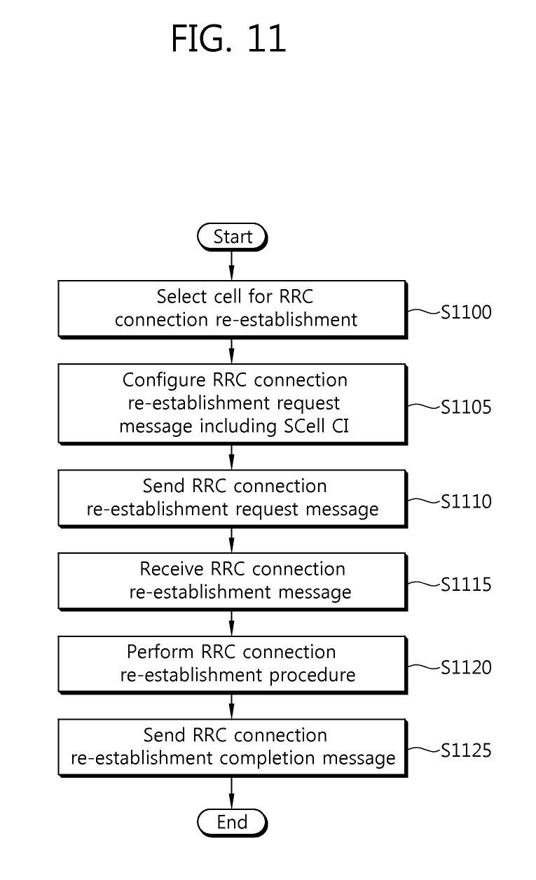

FIG. 11 is a flowchart illustrating the RRC connection re-establishment of UE in accordance with an example of the present invention.

Referring to FIG. 11, if RRC connection with a PCell cannot be now maintained by some reasons, the UE selects a cell for RRC connection re-establishment for a period of time (S1100). An RRC connection re-establishment procedure can be triggered in the following situations. 1) When a Radio Link Failure (hereinafter referred to as an RLF) is detected, 2) When a handover fails, 3) When a check failure indicator is delivered from a lower layer, and 4) When a connection reconfiguration has failed.

When the situations are generated, the UE starts searching for a cell that is determined to be suitable for an attempt for RRC connection re-establishment during a time interval in which the RRC connection re-establishment can be started. The cell may be a cell present in the same network or may be a cell within a heterogeneous network supportable by the UE. The time interval can be defined through a timer (T311 in the case of LTE) defined within the UE. When the timer expires, the UE changes an RRC mode into RRC_IDLE.

If the UE has retrieved a cell suitable for starting the RRC connection re-establishment procedure, the UE configures UE-identity information based on the suitable cell and configures an RRC connection re-establishment request message including SCell CI (S1105). However, in order for the RRC connection re-establishment procedure to be started, all the following conditions must be satisfied. 1) The UE must be in an RRC_CONNECTED mode, 2) Access Stratum (AS) security must be activated, 3) UE context must be valid. In contrast, if all the conditions are not satisfied, the UE changes an RRC mode into RRC_IDLE.

The UE sends the RRC connection re-establishment request message to a BS (S1110) and receives an RRC connection re-establishment message as a response from the BS (S1115). The UE performs an RRC connection re-establishment procedure based on the instruction of the RRC connection re-establishment message (S1120). When the RRC connection re-establishment procedure is completed, the UE sends an RRC connection re-establishment completion message to the BS (S1125).

For example, the RRC connection re-establishment completion message includes SCell Configuration Information (CI). The SCell CI is information that indicates or specifies an SCell configured in the UE, and the SCell CI includes at least one of a cell index, a physical cell ID, a center frequency value of an SCell, and eNB-specific cell index information to distinguish a plurality of cells within the eNB. The eNB-specific cell index information is different from a cell index and is information assigned by the BS.

Here, the cell index is information configured so that a specific BS indicates a serving cell. The cell index is a value that varies according to serving cells configured in each MS and is an independent value every MS. That is, a BS can set a different cell index in each MS in relation to one serving cell that is physically the same.

Meanwhile, the physical cell ID is information configured in order to indicated a serving cell within an LTE system. That is, the physical cell ID is a value for indicating serving cells that can be configured in each of a plurality of eNBs and is a value fixedly set when a system is configured.

Furthermore, the eNB-specific cell index information is information configured so that a specific BS indicates a serving cell. The eNB-specific cell index information is a value that varies according to serving cells configured in each BS and is an independent value every BS. That is, a BS can set a different cell index in each MS in relation to one serving cell that is physically the same.

The eNB-specific cell index information may be transmitted to the UE through an RRC reconfiguration procedure or may be transmitted to the UE through a broadcasting channel, in particular, a System Information Block 2 (SIB2).

For another example, the RRC connection re-establishment completion message includes SCell modification information. For yet another example, the RRC connection re-establishment completion message includes both SCell CI and SCell modification information.

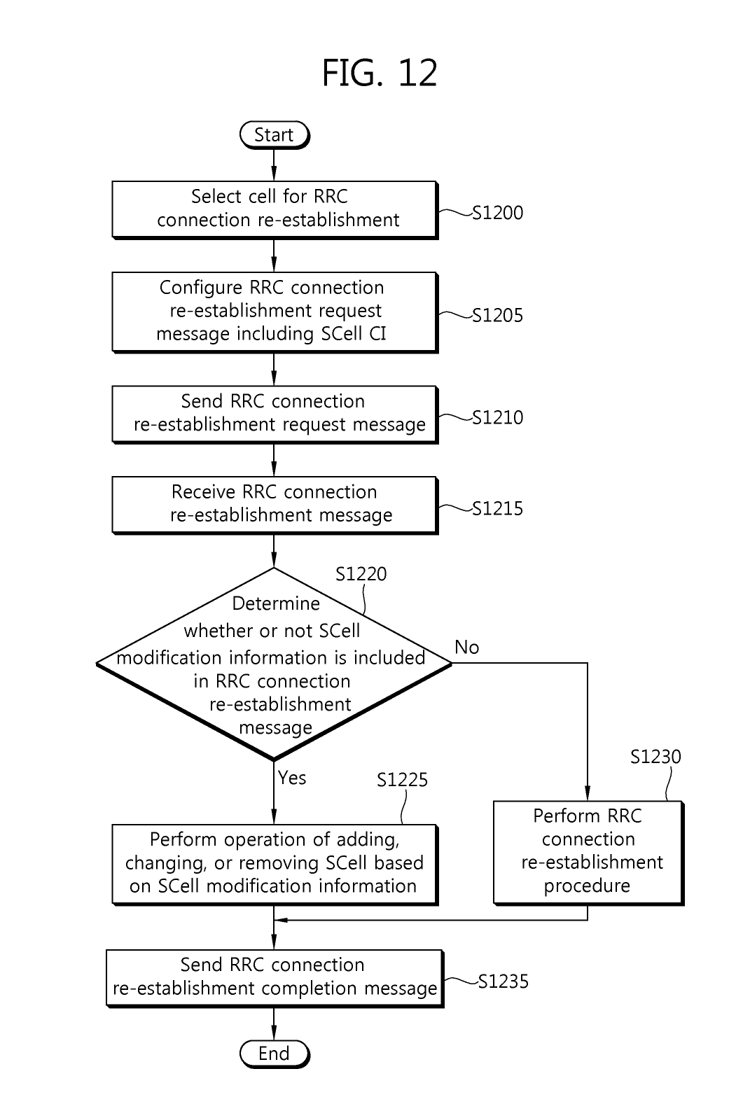

FIG. 12 is a flowchart illustrating the RRC connection re-establishment of UE in accordance with another example of the present invention.

Referring to FIG. 12, steps S1200 to S1215 are the same as the steps S1100 to S1115. FIG. 12 differs from FIG. 11 in that the UE determines whether or not SCell modification information is included in an RRC connection re-establishment message (S1220).

At step S1220, the UE determines whether or not SCell modification information is included in an RRC connection re-establishment message. If the RRC connection re-establishment message includes SCell modification information, the UE performs an operation of adding, changing, or removing an SCell based on the contents of the SCell modification information (S1225). In contrast, if the RRC connection re-establishment message does not includes SCell modification information, the UE performs a common RRC connection re-establishment procedure (S1230). When the RRC connection re-establishment procedure is completed, the UE sends an RRC connection re-establishment completion message to the BS (S1235). Here, the RRC connection re-establishment completion message can include SCell Configuration Information (SCell CI). The SCell CI is information that indicates or specifies an SCell configured in the UE, and the SCell CI includes at least one of a cell index, a physical cell ID, a center frequency value of an SCell, and eNB-specific cell index information.

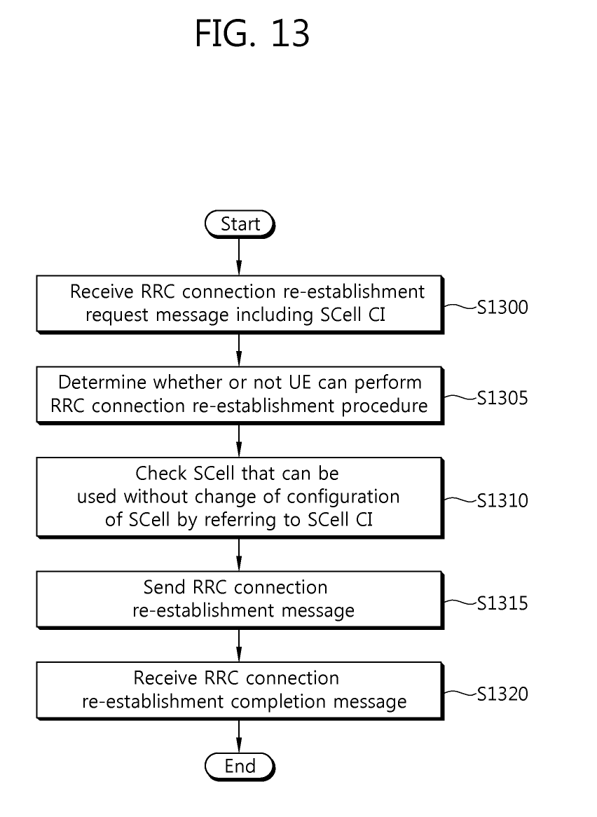

FIG. 13 is a flowchart illustrating the RRC connection re-establishment of a BS in accordance with an example of the present invention.

Referring to FIG. 13, the BS receives an RRC connection re-establishment request message, including SCell CI, from UE (S1300). The SCell CI is information that indicates or specifies an SCell configured in the UE, and the SCell CI includes at least one of a cell index, a physical cell ID, and a center frequency value of an SCell. The BS determines whether or not the UE can perform an RRC connection re-establishment procedure based on the RRC connection re-establishment request message (S1305). If it is determined that the UE cannot perform the RRC connection re-establishment procedure, the BS sends an RRC connection re-establishment denial message to the UE.

If it is determined that the UE can perform the RRC connection re-establishment procedure, the BS checks an SCell that can be used even without a change of the configuration of the SCell by taking the SCell CI received from the UE, a re-establishment cause, and whether or not the SCell can be supported through the BS into consideration (S1310). If SCell CI is not included in the RRC connection re-establishment request message received from the UE, the BS can remove all the SCells of the corresponding UE.

The BS sends an RRC connection re-establishment message to the UE (S1315) and receives an RRC connection re-establishment completion message from the UE (S1320). For example, the RRC connection re-establishment completion message includes SCell Configuration Information (SCell CI). The SCell CI is information that indicates or specifies an SCell configured in the UE, and the SCell CI includes at least one of a cell index, a physical cell ID, a center frequency value of an SCell, and eNB-specific cell index information. For another example, the RRC connection re-establishment completion message includes SCell modification information. For yet another example, the RRC connection re-establishment completion message includes both SCell CI and SCell modification information.

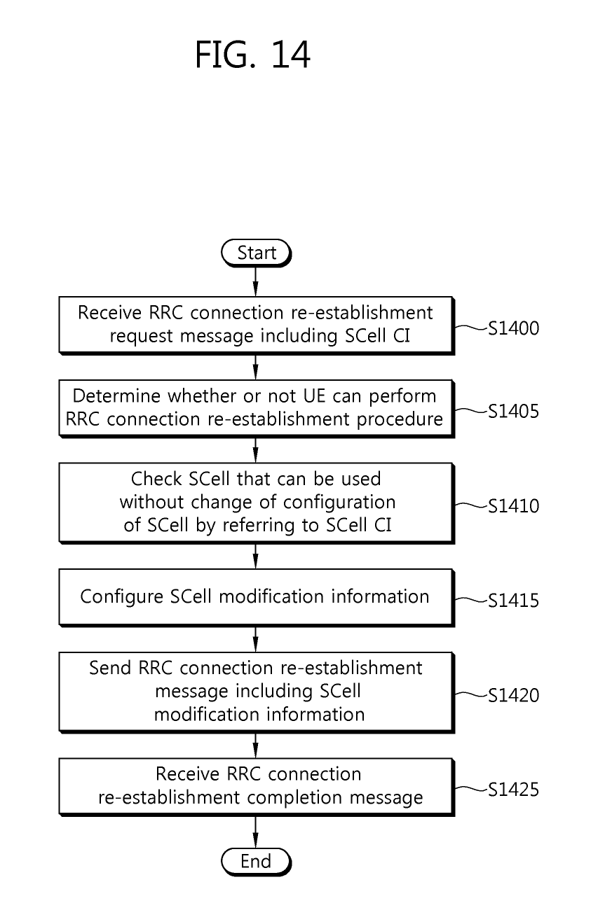

FIG. 14 is a flowchart illustrating the RRC connection re-establishment of a BS in accordance with another example of the present invention.

Referring to FIG. 14, the BS receives an RRC connection re-establishment request message, including SCell CI, from UE (S1400). The SCell CI is information that indicates or specifies an SCell configured in the UE, and the SCell CI includes at least one of a cell index, a physical cell ID, and a center frequency value of an SCell.

The BS determines whether or not the UE can perform an RRC connection re-establishment procedure based on the RRC connection re-establishment request message (S1405). If it is determined that the UE cannot perform the RRC connection re-establishment procedure, the BS send an RRC connection re-establishment denial message to the UE.

If it is determined that the UE can perform the RRC connection re-establishment procedure, the BS checks an SCell that can be used even without a change of the configuration of the SCell by taking the SCell CI received from the UE, a re-establishment cause, and whether or not the SCell can be supported through the BS into consideration (S1410).

If the configuration of an SCell needs to be changed, the BS configures SCell modification information indicative of the change, removal, addition, etc. of at least one SCell (S1415). If the configuration of an SCell does not need to be changed, the BS does not configure additional SCell modification information.

The BS sends an RRC connection re-establishment message, including the SCell modification information, to the UE (S1420) and receives an RRC connection re-establishment completion message from the UE (S1425).

Information included in the RRC connection re-establishment request message, particularly, a SCell CI, UE-identity information, re-establishment cause information, etc. are described in more detail below.

1. UE-Identity Information

The UE-identity information includes three items listed in Table 1.

TABLE 1

C-RNTI(Cell-Radio Network Temporary Identifier
Physical Cell ID for Primary Serving Cell
Encryption information (short MAC-I)

Encryption information is formed of 16 bits using the integrity protection key K_{RRCint} of RRC signaling and an integrity security algorithm.

UE-identity information has a value used in a source cell (a serving cell right before a handover) when a handover within a network or to a heterogeneous network fails. In other cases, UE-identity information has a value used in a cell in which RRC connection re-establishment is now being performed.

2. Re-Establishment Cause Information

The re-establishment cause information is specified as one of three items in Table 2 and formed of the specified item.

Here, In-Device Coexistence (IDC) interference means interference occurring in UE due to other wireless communication systems other than LTE. Accordingly, an ‘failure due to IDC’ means that a radio link has occurred in an LTE system due to IDC interference.

TABLE 2
Reconfiguration failure
Handover failure
In-Device Coexistence (IDC) interference failure (In-device interference
failure)
Other failures

3. SCell Configuration Information (SCell CI)

SCell CI is information that indicates or specifies an SCell configured in UE, and the SCell CI includes at least one of a cell index, a physical cell ID, a center frequency value of an SCell, and eNB-specific cell index information. The cell index, the physical cell ID, and the center frequency value that form the SCell CI can be information known to both UE and a BS. In this case, the UE or the BS is able to be aware of all the remaining two values if they are able to be aware of any one of the cell index, the physical cell ID, and the center frequency value that form the SCell. Accordingly, although any one of the cell index, the physical cell ID, and the center frequency value is included in an RRC connection re-establishment request message or an RRC connection re-establishment completion message, the BS which receives the RRC connection re-establishment request message or the RRC connection re-establishment completion message is also able to be aware of the remaining two information associated with the included value.

Table 3 shows an example of SCell CI when a maximum number of CCs supportable in a system is 8.

TABLE 3

SCell-CI ::=SEQUENCE {cell-Index BIT STRING (SIZE 8),}

Referring to Table 3, the SCell CI includes only the cell index ‘cell-index’ of an SCell, and the position of each of BIT STRING 8 bits corresponds to one SCell. Accordingly, SCell or CC indices No. 0 to No. 7 can be assigned. Since a maximum number of CCs are illustrated as being 8, an SCell can be assigned cell indices from No. 0 to No. (m−1), assuming that a maximum number of CCs supportable in a system are m. One bit indicates 1 or 0, which indicates the configuration or non-configuration of a corresponding SCell. A Least Significant Bit (LSB) means a cell index=0. Assuming that the cell index of a primary serving cell (PCell) is always set to 0, an LSB can be always set to 0 or the length of BIT STRING can be set to m−1 and an LSB within BIT STRING may mean a cell index=1.

Table 4 shows another example of SCell CI.

TABLE 4
SCell-Info ::=SEQUENCE (SIZE (1..maxSCell)) of SCell-CISCell-CI
::=SEQUENCE {physCellId PhysCellId,}

Referring to Table 4, the SCell CI includes only the physical cell ID ‘physCellID’ of an SCell.

Table 5 shows yet another example of SCell CI.

TABLE 5

SCell-Information ::=SEQUENCE (SIZE (1..maxSCell)) of
SCellInfoSCellInfo ::=SEQUENCE {carrierFreq CarrierFreq,}

Referring to Table 5, the SCell CI includes only a center frequency value ‘carrierFreq’ of an SCell.

Table 6 shows yet another example of SCell CI.

TABLE 6
SCell-CI ::= SEQUENCE {cell-Index BIT STRING (SIZE 8), PCI-
Information ::=SEQUENCE (SIZE (1..maxSCell)) of PCIInfo PCIInfo::=
SEQUENCE {physCellId PhysCellId,} CaFreq-Information ::=
SEQUENCE (SIZE (1..maxSCell)) of CaFreqInfo CaFreqInfo
::=SEQUENCE {carrierFreq CarrierFreq,}}

Referring to Table 6, the SCell CI includes all a cell index, a physical cell ID, and a center frequency value. A physical cell ID and a center frequency value for an SCell, corresponding to a position set to ‘1’ in the cell index field ‘cell-Index’, are set. In contrast, a physical cell ID and a center frequency value for an SCell, corresponding to a position set to ‘0’ in the cell index field ‘cell-Index’, are set to ‘NULL’ or a value having the meaning of a meaningless value. For example, in the case where BIT STRING of the cell index is 4 bits, if BIT STRING is {1, 0, 1, 1}, a physical cell ID field, corresponding to one cell index having a bit value of 0, and a center frequency value field are indicated by ‘NULL’, and a physical cell ID field, corresponding to three cell indices each having a bit value of 1, and a center frequency value field are set to specific values.

For example, SCell CI may be present within an RRC connection re-establishment request message or an RRC connection re-establishment completion message independently from UE-identity information.

Table 7 is part of an RRC connection re-establishment request message in accordance with an example of the present invention.

TABLE 7
SCell-CI ::= SEQUENCE (SIZE (1..maxSCell)) of SCellInfoSCellInfo
::=SEQUENCE {cell-Index Cell-Index, physCellId PhysCellId, carrierFreq
CarrierFreq, eNBspecificCell-index ENBCell-index}

Referring to Table 7, an RRC connection re-establishment request message or an RRC connection re-establishment completion message includes all of a cell index, a physical cell ID, a center frequency value, and eNB-specific cell index information as SCell CI.

Table 8 is part of an RRC connection re-establishment request message in accordance with another example of the present invention.

TABLE 8
SCell-CI ::=SEQUENCE (SIZE (1..maxSCell)) of SCellInfoSCellInfo
::=SEQUENCE {cell-Index Cell-Index, eNBspecificCell-index
ENBCell-index}

Referring to Table 8, an RRC connection re-establishment request message or an RRC connection re-establishment completion message includes a cell index and eNB-specific cell index information as SCell CI.

Here, the cell index is information used when a specific BS is able to be aware of UE that requests RRC connection re-establishment.

The eNB-specific cell index information is information used when a specific BS is unable to be aware of UE that requests RRC connection re-establishment.

Accordingly, UE may select only one of the cell index and the eNB-specific cell index information and send the selected one.

Table 9 is part of an RRC connection re-establishment request message in accordance with yet another example of the present invention.

TABLE 9

ReestabUE-Identity ::=SEQUENCE {c-RNTI C-RNTI, physCellId
PhysCellId, shortMAC-I ShortMAC-I, SCell-CI SCell-CI
}

Referring to Table 9, UE-identity information ‘ReestabUE-Identity’ for a reconfiguration includes SCell CI.

For example, the SCell CI can be absorbed by/included in UE-identity information.

Table 10 is part of an RRC connection re-establishment request message or an RRC connection re-establishment completion message in accordance with yet another example of the present invention.

TABLE 10

ReestabUE-Identity ::=SEQUENCE {c-RNTI C-RNTI, physCellId
PhysCellId, shortMAC-I ShortMAC-I} SCell-CI ::=SEQUENCE
{cell-Index BIT STRING (SIZE (8))}

Referring to Table 10, SCell CI is separated from UE-identity information ‘ReestabUE-Identity’ for a reconfiguration and present within an RRC connection re-establishment request message or an RRC connection re-establishment completion message. In particular, the SCell CI includes only a cell index.

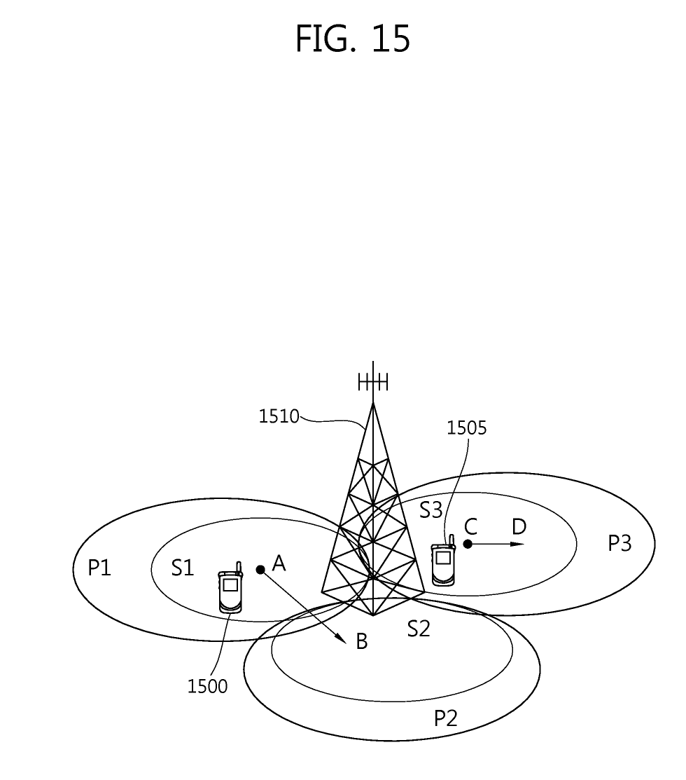

FIG. 15 shows a scenario by which the configuration of a serving cell is changed in accordance with an example of the present invention. This scenario corresponds to a case where both a PCell and an SCell are changed or not changed.

Referring to FIG. 15, for example, a case where a Radio Link Failure (RLF) has occurred while UE 1500 moves from a point A to a point B is taken into consideration. At the point A, the PCell of the UE 1500 is configured as the uplink/downlink CC of a P1 band, and an SCell of the UE 1500 is configured as the uplink/downlink CC of an S1 band.

When the RLF occurs, the UE 1500 searches for a cell with which RRC connection re-establishment will be performed. Here, if the UE 1500 has satisfied requirements for the RRC connection re-establishment while moving to the point B and has selected a cell, configured as the uplink/downlink CC of a P2 band, as a cell suitable for the RRC connection re-establishment, the UE 1500 performs an RRC connection re-establishment procedure through the to cell of the P2 band. This procedure is accompanied by a procedure for changing the PCell from the P1 band to the P2 band.

Meanwhile, the UE 1500 can include SCell CI, including at least one of a cell index, physical cell ID, center frequency value, and eNB-specific cell index information of an SCell S1 configured when the RLF was generated, in an RRC connection re-establishment request message or an RRC connection re-establishment completion message and send the RRC connection re-establishment request message or the RRC connection re-establishment completion message to a BS 1510. Since the UE 1500 has moved to the point B in which all SCells configurable at the point A are not supported, the BS 1510 performs a procedure of removing all the previously configured SCells. The BS 1510 can perform a procedure of adding SCells that can be configured at the point B.

For another example, a case where an RLF occurs while UE 1505 moves from a point C to a point D is taken into consideration. At the point C, the UE 1505 has configured and used a cell, configured as the uplink/downlink CC of a P3 band, as a PCell and has configured and used a cell, configured as the uplink/downlink CC of an S3 band, as an SCell. If the UE 1505 performs RRC connection re-establishment using the P3 band as the PCell at the point D (or point C) after the RLF was generated at the point C, the SCell configured between the corresponding UE 1505 and the BS 1510 does not need to be changed (or removed).

If the UE 1505 changes the S3 band into the PCell at the point D and then performs RRC connection re-establishment, however, the SCell needs to be changed. Accordingly, the UE 1505 can include SCell CI, including at least one of a cell index, physical cell ID, center frequency value, and eNB-specific cell index information of the SCell S3 configured when the RLF was generated, in an RRC connection re-establishment request message and send the RRC connection re-establishment request message to the BS 1510 or can include the SCell CI in an RRC connection re-establishment completion message used when the RRC connection re-establishment procedure is completed and send the RRC connection re-establishment completion message to the BS 1510. Here, the BS 1510 performs a procedure for removing the SCell S3, but does not remove the remaining SCells. This is because the SCell S3 configured previously has been configured as a PCell. The BS 1510 can perform a procedure for changing the SCells not removed and a procedure for adding an SCell at the same time, if necessary.

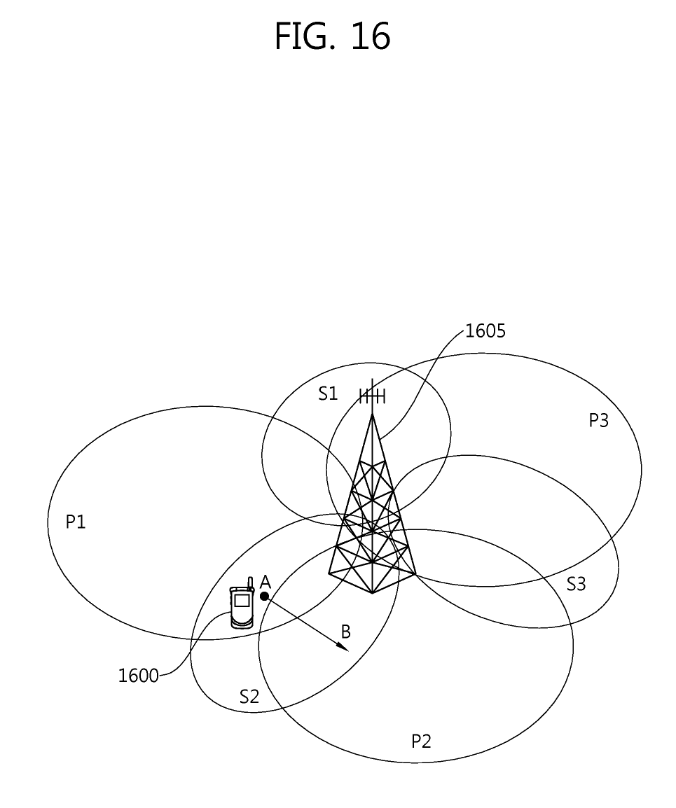

FIG. 16 shows a scenario by which the configuration of a serving cell is changed in accordance with another example of the present invention. The scenario corresponds to a case where a PCell is changed, but an SCell is not changed.

Referring to FIG. 16, an RLF is generated while UE 1600 moves from a point A to a point B. At the point A, the PCell of the UE 1600 is configured as the uplink/downlink CC of a P1 band, and an SCell of the UE 1600 is configured as the uplink/downlink CC of an S2 band.

When the RLF occurs, the UE 1600 searches for a cell with which RRC connection re-establishment will be performed. Here, if the UE 1600 has satisfied all requirements for the RRC connection re-establishment while moving to the point B and selected a cell, configured as the uplink/downlink CC of a P2 band, as a cell suitable for the RRC connection re-establishment, the UE 1600 performs an RRC connection re-establishment procedure through the cell of the P2 band. This procedure is accompanied by a procedure for changing the PCell from the P1 band to the P2 band. Meanwhile, an SCell is S2 at the point B and is the same as that at the point A. Accordingly, in this case, the SCell does not need to be changed.

If the UE 1600 changes the S2 band as a PCell at the point B and performs the RRC connection re-establishment, the SCell needs to be changed. Accordingly, the UE 1600 can include SCell CI, including at least one of a cell index, physical cell ID, center frequency value, and eNB-specific cell index information of the SCell S2 configured when the RLF was generated, in an RRC connection re-establishment request message or an RRC connection re-establishment completion message and send the RRC connection re-establishment request message or the RRC connection re-establishment completion message to a BS 1605. Here, the BS 1605 performs a removal procedure on S2 as the SCell, but does not remove the remaining SCells. This is because S2, that is, a previously configured SCell, has been changed into and configured as a PCell. The BS 1605 can perform a procedure for changing the SCells not removed and a procedure for adding an SCell at the same time, if necessary.

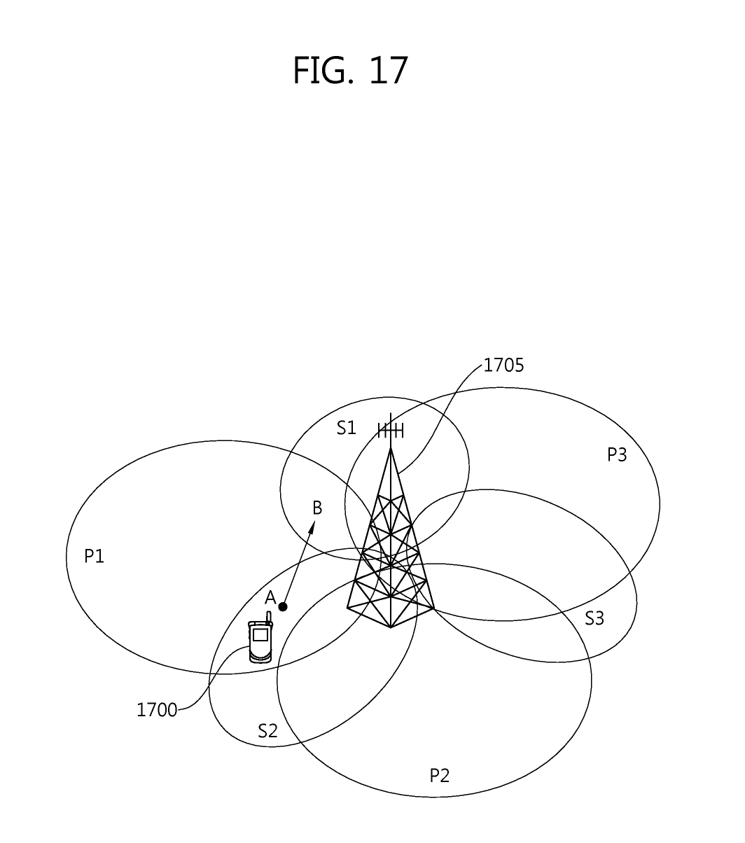

FIG. 17 shows a scenario by which the configuration of a serving cell is changed in accordance with yet another example of the present invention. The scenario corresponds to a case where a PCell is not changed, but only an SCell is changed.

Referring to FIG. 17, an RLF is generated while UE 1700 moves from a point A to a point B. At the point A, the PCell of the UE 1700 is configured as the uplink/downlink CC of a P1 band, and an SCell of the UE 1700 is configured as the uplink/downlink CC of an S2 band.

When the RLF occurs, the UE 1700 searches for a cell with which RRC connection re-establishment will be performed. Here, if the UE 1700 has satisfied requirements for the RRC connection re-establishment while moving to the point B and has selected a cell, configured as the uplink/downlink CC of the existing P1 band, as a cell suitable for the RRC connection re-establishment, the UE 1700 performs an RRC connection re-establishment procedure through the cell of the existing P1 band. Meanwhile, since an SCell is S1 at the point B, the SCell is different from an SCell at the point A. Accordingly, in this case, the SCell needs to be changed.

To this end, the UE 1700 can include SCell CI, including at least one of a cell index, physical cell ID, center frequency value, and eNB-specific cell index information of the SCell S2 configured when the RLF was generated, in an RRC connection re-establishment request message or an RRC connection re-establishment completion message, and send the RRC connection re-establishment request message or the RRC connection re-establishment completion message to a BS 1705. Here, the BS 1705 can perform a removal procedure on other SCells that cannot be supported in addition to S2 as an SCell, but may not remove the remaining SCells. The BS 1705 can perform a procedure for adding an SCell at the same time, if necessary.

As described with reference to FIGS. 15 to 17, if SCell information in a Carrier Aggregation (CA) environment in which RRC connection re-establishment is now performed is different from SCell information in a CA environment prior to an RRC connection re-establishment procedure, a change of a configuration through addition/change/removal for an SCell previously configured between UE and a BS can be performed using SCell CI when performing an RRC connection re-establishment procedure.

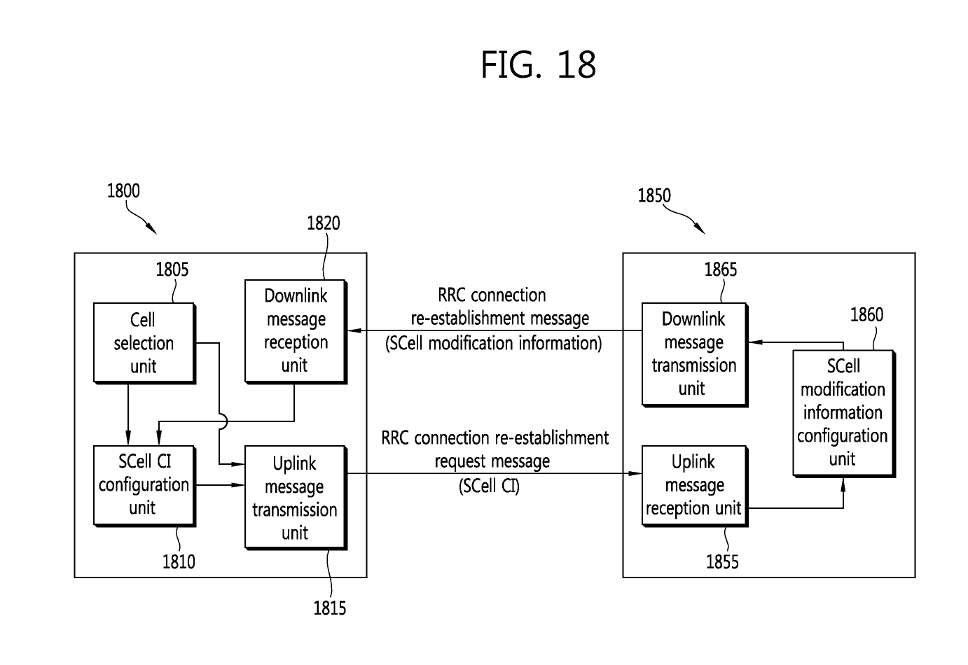

FIG. 18 is a block diagram of UE and a BS which perform RRC connection re-establishment in accordance with an example of the present invention.

Referring to FIG. 18, the UE 1800 includes a cell selection unit 1805, an SCell CI configuration unit 1810, an uplink message transmission unit 1815, and a downlink message reception unit 1820.

The cell selection unit 1805 selects a cell for RRC establishment or re-establishment. The RRC connection re-establishment procedure can be started under situations 1) when an RLF is detected, 2) when a handover fails, 3) when a check failure indicator is delivered from a lower layer, and 4) when a connection reconfiguration has failed. When the situations are generated, the cell selection unit 1805 starts searching for a cell that is determined to be suitable for an attempt for RRC connection re-establishment during a time interval in which the RRC connection re-establishment can be started. The cell may be a cell present in the same network or may be a cell within a heterogeneous network supportable by the UE. The time interval can be defined through a timer (T311 in the case of LTE) defined within the UE. When the timer expires, the cell selection unit 1805 changes the mode of the UE 1800 into RRC_IDLE. If the cell selection unit 1805 has retrieved a cell suitable for starting a radio connection re-establishment procedure, the cell selection unit 1805 configures UE-identity information based on the suitable cell.

The SCell CI configuration unit 1810 configures SCell CI that specifies at least one SCell configured in the UE 1800. The SCell CI is information that indicates or specifies an SCell configured in the UE, and the SCell CI includes at least one of a cell index, physical cell ID, center frequency value, and eNB-specific cell index information of the SCell. In particular, the SCell CI configuration unit 1810 can configure the SCell CI based on a point of time prior to the start of an RRC connection re-establishment procedure. As described above, the SCell CI configuration unit 1810 can specify which SCells configured in the UE will be selected through the SCell CI when an RLF occurs. The SCell CI can be defined as in Tables 3 to 10.

The uplink message transmission unit 1815 sends an RRC connection re-establishment request message or an RRC connection re-establishment completion message, including the SCell CI, to the BS 1850. For example, the RRC connection re-establishment request message or the RRC connection re-establishment completion message can include UE-identity information, and the SCell CI can be transmitted in a form in which the SCell CI is included in the UE-identity information. For another example, the RRC connection re-establishment request message or the RRC connection re-establishment completion message can include UE-identity information, and the SCell CI can be transmitted in a form independent from the UE-identity information.

The downlink message reception unit 1820 receives an RRC connection re-establishment message, including SCell modification information, from the BS 1850.

The BS 1850 includes an uplink message reception unit 1855, an SCell modification information configuration unit 1860, and a downlink message transmission unit 1865.

The uplink message reception unit 1855 receives an RRC connection re-establishment request message or an RRC connection re-establishment completion message from the UE 1800 and extracts SCell CI included in the RRC connection re-establishment request message or the RRC connection re-establishment completion message. Through the extraction, the uplink message reception unit 1855 obtains at least one of a cell index, a physical cell ID, a center frequency value of an SCell, and eNB-specific cell index information and transfers them to the SCell modification information configuration unit 1860.

The SCell modification information configuration unit 1860 checks at least one SCell configured in the UE 1800 based on at least one of the cell index, the physical cell ID, the center frequency value of the SCell, and the eNB-specific cell index information received from the uplink message reception unit 1855 and configures SCell modification information on which the configuration of the at least one SCell configured in the UE 1800 is modified (i.e., remove, change, or add an SCell) according to various scenarios, such as those of FIGS. 15 to 17. The SCell modification information includes information about the addition/change/removal of an SCell.

The downlink message transmission unit 1876 sends an RRC connection re-establishment message, including the SCell modification information, to the UE 1800.

All the functions described above can be executed by a microprocessor, a controller, a microcontroller, or a processor, such as an Application Specific Integrated Circuit (ASIC) based on software or a program code coded to execute the functions. The design, development, and implementation of the codes can be said to be evident to those skilled in the art based on the description of the present invention.

Although the embodiments of the present invention have been described above, a person having ordinary skill in the art will appreciate that the present invention can be modified, changed, and implemented in various ways without departing from the technical spirit and scope of the present invention. Accordingly, the present invention is not limited to the embodiments, and the present invention can be said to include all embodiments within the scope of the claims below.

1. A User Equipment (UE) performing radio connection re-establishment in a multiple component carrier system, the UE comprising:
a cell selection unit selecting a cell for re-establishment of radio connection when the radio connection fails;
a secondary cell configuration information (SCell CI) configuration unit configuring SCell CI that specifies at least one secondary serving cell configured in the UE;
a message transmission unit sending a radio connection re-establishment request message, requesting an re-establishment procedure of the radio connection, and a radio connection re-establishment completion message, indicating that the radio connection re-establishment procedure has been completed, to an evolved-NodeB (eNB) through the selected cell; and
a message reception unit receiving a radio connection re-establishment message as a response to the radio connection re-establishment request message,
wherein the SCell CI is included in at least one of the radio connection re-establishment request message and the radio connection re-establishment completion message.

2. The UE of claim 1, wherein:
the SCell CI configuration unit configures at least one of a cell index, physical cell identifier (ID), a center frequency value, and eNB-specific cell index information of the at least one secondary serving cell into the SCell CI,
the cell index is an index used when the eNB is able to be aware of that the UE is UE requesting Radio Resource Control (RRC) connection re-establishment, and
the eNB-specific cell index is an index used when the eNB knows that the UE is unable to be aware of UE requesting RRC connection re-establishment.

3. The UE of claim 2, wherein the cell index has a bit number equal to a maximum number of secondary serving cells supportable in a system.

4. The UE of claim 3, wherein:
when a bit of the cell index is 1, a secondary serving cell corresponding to the bit is configured in the UE, and
when a bit of the cell index is 0, a secondary serving cell corresponding to the bit is not configured in the UE.

5. The UE of claim 4, wherein when a bit of the cell index is 0, the physical cell ID or the center frequency value regarding a secondary serving cell corresponding to the bit are set to ‘NULL’.

6. The UE of claim 1, wherein the radio connection is RRC connection performed in an RRC layer.

7. The UE of claim 1, wherein the SCell CI configuration unit configures the SCell CI by including the SCell CI in UE-identity information.

8. The UE of claim 1, wherein the SCell CI configuration unit configures the SCell CI separately from UE-identity information.

9. A method of User Equipment (UE) performing radio connection re-establishment in a multiple component carrier system, the method comprising steps of:
selecting a cell for re-establishment of radio connection when the radio connection fails;
configuring secondary cell configuration information (SCell CI) that specifies at least one secondary serving cell configured in the UE;
sending a radio connection re-establishment request message, requesting the re-establishment of the radio connection to an evolved-NodeB (eNB) through the selected cell;
receiving a radio connection re-establishment message as a response to the radio connection re-establishment request message; and
sending a radio connection re-establishment completion message, indicating that a radio connection re-establishment procedure has been completed, to the eNB through the selected cell,
wherein the SCell CI is included in at least one of the radio connection re-establishment request message and the radio connection re-establishment completion message.

10. An evolved-NodeB (eNB) performing radio connection re-establishment in a multiple component carrier system, the eNB comprising:
an uplink message reception unit receiving a radio connection re-establishment request message, requesting re-establishment of radio connection, or a radio connection re-establishment completion message, indicating that a radio connection re-establishment procedure has been completed, from User Equipment (UE) through a primary serving cell;
an secondary cell (SCell) modification information configuration unit making a determination of whether to remove or change at least one secondary serving cell configured in the UE with reference to SCell Configuration Information (CI), included in at least one of the radio connection re-establishment request message and the radio connection re-establishment completion message and specifying the at least one secondary serving cell, and configuring SCell modification information indicative of an addition, removal, or change of a secondary serving cell based on the determination; and
a downlink message transmission unit sending a radio connection re-establishment message, comprising the SCell modification information, to the UE as a response to the radio connection re-establishment request message.

11. The eNB of claim 10, wherein the SCell CI comprises at least one of a cell index, physical cell identifier (ID), a center frequency value, and eNB-specific cell index information of the at least one secondary serving cell into the SCell CI,
the cell index is an index used when the eNB is able to be aware of that the UE is UE requesting Radio Resource Control (RRC) connection re-establishment, and
the eNB-specific cell index is an index used when the eNB knows that the UE is unable to be aware of UE requesting RRC connection re-establishment.

12. The eNB of claim 10, wherein the at least one secondary serving cell comprises a downlink component carrier and an uplink component carrier.

13. A method of an evolved-NodeB (eNB) performing radio connection re-establishment in a multiple component carrier system, the method comprising steps of:
receiving a radio connection re-establishment request message, requesting re-establishment of radio connection when the radio connection fails, or a radio connection re-establishment completion message, indicating that the re-establishment of the radio connection has been completed, from User Equipment (UE) through a primary serving cell; and
sending a radio connection re-establishment message, comprising secondary serving cell (SCell) modification information indicating whether at least one secondary serving cell configured in the UE is to be removed or changed based on SCell configuration information included in at least one of the radio connection re-establishment request message and the radio connection re-establishment completion message and specifying the at least one secondary serving cell, to the UE.
